(19) United States
(12) Patent Application Publication
(10) Pub. No.: US 2015/0231020 A1
(43) Pub. Date: Aug. 20, 2015

(54) Automated Variable Zoom Software (AVZS) for Exercising the Eyes

(71) Applicant: David James Battin, Cocoa, FL (US)

(72) Inventor: David James Battin, Cocoa, FL (US)

(21) Appl. No.: 14/625,207

(22) Filed: Feb. 18, 2015

Related U.S. Application Data
(60) Provisional application No. 61/966,049, filed on Feb. 18, 2014.

(51) Int. Cl. A61H 5/00; A63B 24/00

(52) U.S. Cl. CPC A61H 5/00; A63B 24/0087

(57) ABSTRACT

A moving image-type eye exercise software, Automated Variable Zoom Software or AVZS, incorporated via software into a computing device visual task utilizing a window (graphical control element) such as reading, writing, graphics, games, etc. The software incorporation method is stand-alone application, incorporated module, or plug-in software application. The moving image is the window itself. The movements are repeated cyclically and constitute oscillations in the three fundamental directions: perpendicular to display (virtual), horizontal, and vertical. The oscillations are governed by code that ensures constant clarity and visually smooth and subtle transitions. These oscillations occur automatically, upon enabling AVZS, whilst the user is actively engaged in the visual task; thus, the user is able to alleviate eye strain and/or strengthen eyes without further burdening the eyes and without dedicating otherwise additional time and effort just to perform eye exercise.

### CROSS REFERENCES TO RELATED APPLICATIONS

Prior Publication Data: Provisional Patent #61/966,049
Filing Date: Feb. 18, 2014

### PRIOR ART REFERENCES

U.S. Patent Documents
4,408,846 Balliet Oct. 11, 1983
4,756,305 Mateik, et al Jul. 12, 1988
4,838,677 Bronskill, et al Jun. 13, 1989
5,051,931 Cheu, et al Sep. 24, 1991
5,384,593 Gell, Jr., et al Jan. 24, 1995
5,933,130 Wagner Aug. 3, 1999
6,270,467 Yee Aug. 7, 2001
6,592,223 Stern, et al Jul. 15, 2003
7,354,156 McLeod Apr. 8, 2008
7,866,817 Polat Jan. 11, 2011
8,188,990 Zamorsky, et al May 29, 2012
8,702,233 Sahraie Apr. 22, 2014

### OTHER REFERENCES

The Cure of Imperfect Sight by Treatment Without Glasses by William Bates, MD; Copyright 1920
Presbyopia Reduction By Ray Gottlieb, O.D., Ph.D.

### BACKGROUND OF INVENTION

Prior to the 1990s, eye exercise devices were primarily mechanical in nature. After computers had become an important part of both work and home life, software-type eye exercises were developed. Interestingly, the software-type eye exercise sought to alleviate the problems created, in part, by the products of software: strain due to the prolonged viewing of the display which is incidental to the work tasks engaged at home and work; however, this development did make convenient eye exercise available to anyone who cared to engage in such activity due to its compactness and low cost. The most popular of the eye exercise software on the market utilize moving images; other types utilize conditioned blinking, ergonomics, and display color/intensity variation. The ubiquity of the moving image-type exercise software evidences the effectiveness and popularity of such exercise; however, none of them are incorporated into the work tasks that cause the eye strain: they are not simultaneous. As such, they fail to remedy the additional burden, on time, effort, and the eyes, created by use of their respective exercise. An exception is found in Pat. No. 5,933,130 which is discussed below. Amongst the related prior Art, the first three and Pat. No. 7,354,156 are of the mechanical type: their mechanical nature precludes them from competing with the present Invention. The remainder is of the software variety. The evolutionary contributions made towards, and/or short-comings to be resolved within, the patent class by the included prior Art are provided for each.

It is noted that the moving image-type eye exercise software does indeed employ moving images within the two dimensions present upon the display: horizontal, vertical, and rotation. Movement in the third dimension (depth) is virtual and is merely simulated by increasing and decreasing magnification. This simulation is also but an approximation and applies only beyond a certain distance from the eyes. A letter that is printed upon paper which is placed just an inch away from the eyes neither fills the entire visual field nor appears overly large. A letter magnified to the extent that it might be interpreted to appear to be an inch from the eyes, and neglecting issues of resolution, merely seems like a large object which is not so close to the eyes. It is not within the scope of the present Patent to suggest or propose an equivalence between actual and virtual motion or proximity in the dimension perpendicular to the plane of the display; nevertheless, the present Patent and, presumably, the prior Art do assert that benefit may still be obtained from exercise that utilizes such a simulation; and, discussion of such movement is construed to be within the boundaries of this understanding.

Pat. No. 4,408,846 describes a mechanical vision therapy apparatus in which the visual target is moved or not and with or without the interposition of a lens and/or other devices positioned between the target and the observer. The inclusion of this Art in this section merely highlights the basic nature of typical vision therapy: actual or apparent moving visual targets. It is noted that this prior Art includes, essentially, epicyclic motion of the visual target.

Pat. No. 4,756,305 describes a mechanical apparatus which highlights the need for high frequency training and dedication, and seeks to resolve such issues: “A patient is quickly bored when vision training is conducted on this and similar instruments. Since improvements in vision depend heavily on the motivation of the patient and the frequency of therapy, progress is typically quite slow.”

Pat. No. 4,838,677 describes a mechanical apparatus by which essentially epicyclic motion amongst other variations of movement of the target is employed at the limits of visual focus with the goal of creating a superior eye exercise: “It is to be emphasized that the repetitive procedure of bringing an image into and just out of focus combined with the appropriate increase and decrease in image size enables the eye to respond effectively to these cues, by gradually training the ciliary muscle to manipulate the lens.” Also, “A number of variations of the eye exercising device in FIG. 1 are contemplated, including the use of a computer 32 to monitor or adjust continuously or as required the type of motion (for example linear or sinusoidal), the rate of motion, the range of motion, and the frequency of motion cycles of the slide 12, to optimise the effectiveness of the device.”

Pat. No. 5,051,931 describes one of the first computer-based eye exercise devices; that is, eye exercise software. It is quite specific about its modality as an independent eye exercise routine: “ . . . utilizing a computer connected to a computer display screen, featuring Eye Movement, Fusion and Focusing Exercises that can be used separately or as a single unit. It is a further object to provide a method of Eye Movement and Fusion Exercises and apparatus, therefore, that have the option of giving the user a quantitative result indicating the user's level of accomplishment in the exercises.” It provided the template for eye exercise software: “Known eye exercises to this date have been used primarily for diagnosing or testing for eye problems. Even relatively simple exercises have not been developed for many eye problems. Those that have been developed strictly as exercises to strengthen the eye muscles, have not offered a full range of necessary exercise, have been rather crude, have not offered progressive training, or have not offered quantitative measures of progress or ability related to the exercises. Furthermore, these exercises have not been capable of easily and inexpensively being integrated into a computer user's environment or providing immediate feedback to the individual user.” Despite its contribution, this prior Art does not address the issues of exercise burden.

Pat. No. 5,933,130 is most interesting within its class and with respect to the present Invention. It is an exception within this list as it does not employ apparent or actual moving visual targets. It is also striking that the device is apparently a simultaneous exercise as it works in the background; and, that the corresponding variations can be made imperceptible or not to the user. Though the Art runs parallel to the present Invention with respect to controls, purpose, and that it is simultaneous exercise, a substantial difference is obviated by the disclosed means to obtain the goal of improving visual acuity and/or reducing eye strain. The present Invention manipulates apparent focal length and image position/orientation; however, the prior Art manipulates image/display color and brightness: “ . . . Applicant believes that very active movement of the muscles of the eye should also be avoided to prevent fatigue. Accordingly, the brightness of the display is preferably adjusted so that the muscles of the eye are regularly exercised, but not to the extent that the eye muscles are fatigued;” and, “ . . . selecting a pattern from a plurality of patterns in accordance with which a display is desired to be varied, the display being varied by varying one or more of the following: intensity, brightness, contrast, backlight, gray scale and color level; . . . ” Additionally, references evidence, and the majority of prior Art suggest, that the manipulation of focal length, apparent or otherwise, and of image orientation are the preferred means to strengthen the eyes.

Pat. Nos. 5,384,593, 6,270,467, and 8,188,990 describe Art that centers about training the user to blink in an effort to relieve eye strain which is, at best, a tangential Art relative to the present Patent. Similarly, the ergonomic-type Art described in Pat. Nos. 6,592,223 and 8,702,233, which focus on regulating the distance between the user and the computer display, are equally distant.

Pat. No. 7,354,156 introduces Art that utilizes the concept that the relative rotation of a visual target assists in the strengthening of eyes:“ . . . subject maintaining a line horizontally through the pupils' centers parallel to a horizontal line through the visual target during vertical angular displacements of the head. In accordance with a fourth aspect of the invention the subject maintains the fixation of the eyes on the central part of the visual target while rotating the head to a first angle, blinking the eyes several times, and rotating the subject's head in the reverse direction. In accordance with a fifth aspect of the invention, the rotation of the head is done . . . ”Though a similar aspect is included in the present Patent, the basis and implementation is substantially different.

In U.S. Pat. No. 7,866,817, the inventor introduces a convenient method of eye exercise—described in the most general of terms—brought about primarily via wireless communications and portable devices; however, the aforementioned burdens are not addressed.

### SUMMARY OF INVENTION

It is therefore a purpose of the present Invention to provide a moving image-type eye exercise method and device that is incorporated into a work task; that is, simultaneous exercise software for the eyes. This characteristic alleviates the burdens placed upon time, effort, and the eyes of the individual who wishes to improve eyesight and/or reduce or prevent eye strain. The method and device of this Patent manifest as a stand-alone, an incorporated module, or a plug-in software application, known henceforth as AVZS or Automated Variable Zoom Software, that affects the target application and moves, for the purpose of exercising the eyes, the visual target which consists of the entire target application window or part thereof. The movement, which forms a set of four oscillations modes (cyclical motion), are: depth; vertical; horizontal; and, rotation. The parameters for each oscillation mode, which are based upon ergonomics and the limits of the hardware and/or software, may be fixed within the software or provided as a user-defined range within a maximum and minimum. Upon enabling AVZS within the executed target application or executing the stand-alone AVZS, in a most general case and for which the default parameters are utilized, the visual target begins to oscillate at least in one of the four modes and within the boundaries specified by the corresponding parameters. Each oscillation mode is governed by code that that ensures visually smooth and subtle transitions, and constant clarity, of the visual target from one position to the next. Where user-defined parameters are permitted, a mode may be deactivated by setting the corresponding parameters to zero. The depth mode changes the apparent focal length of the target via changes in magnification: the target cyclically zooms in and out. The vertical mode oscillates the target vertically; the horizontal mode oscillates the target horizontally; and, the rotation mode rotates the target alternatingly clockwise and counter-clockwise about an axis perpendicular to the display. These oscillations occur automatically, upon enabling AVZS, and whilst the user is actively engaged in a work task that utilizes the target application window; thus, the user is able to alleviate eye strain and/or strengthen eyes without needing to dedicate extraneous time and effort to perform just eye exercise. The dedication for the exercise need not rise above merely the employing AVZS with the work task software (target application) because the dedication to the work task ensures that the exercise will be performed. Through standard desktop/application icons and interactive windows, the user may activate, exit, and/or modify the parameters of, AVZS.

### DETAILED DESCRIPTION OF THE EXEMPLARY EMBODIMENT

The following detailed description is of the best presently contemplated manner of carrying out the present Invention. This description is made merely for the purpose of illustrating the general principles in accordance with the present Invention. The scope of the present Invention, AVZS, is best defined by the appended claims.

AVZS may be coded as a stand-alone program that controls, a plug-in for, or a module within the target application which is existing software. The first method is as a stand-alone program in which case the target application would be identified within AVZS parameters upon executing AVZS. Whilst seemingly most generalized in applicability, this method introduces coding complications and performance delays. The second method of coding AVZS is as a plug-in: in this case, the target application must be designed with a sufficient service interface to correspond to such an plug-in. If the target application does support plug-ins, such as MS Office, then executing AVZS to act upon target application window would entail installing and enabling the add-on that has been specifically coded to perform AVZS within the target application. Employing this second method generally may be hindered by restrictions on the plug-in service interface within the various desired target applications and by the possibility that the desired target application may simply not support plug-ins. If the target application does not support plug-ins, like Site Spinner (web site creator), then AVZS could be coded as an included module; that is, the target application source code itself would be modified. Due to detriments inherent in the plug-in and stand-alone methods and for the purpose of this exemplary embodiment, the module method will be utilized; that is, those individuals skilled in the Art, whilst possibly possessing the skill to readily overcome the obstacles and objections to the other methods, should likely find an embodiment that employs the module method simplest to envision and code.

Coding for magnification, lateral motion, and rotation of an image is readily accomplished by those individuals skilled in the Art. That these movements, constituting oscillations, are automated and cyclical offers no coding obstacles. Each oscillation mode is governed parameters utilized by code that ensures constant clarity, and visually smooth and subtle transitions, of the visual target from one position to the next. All enabled oscillations occur simultaneously.

It is also given that the magnitude of the movements are constrained by screen dimensions such that target application window is always fully functional and accessible; hence, magnification level or, rather, the target application window absolute size, plays a role in movement constraints and parameters. Whilst it is given that the software may accommodate and execute other modes of oscillations and/or patterns of movement of the visual target such as the addition of pseudo-epicyclic motion (intermittently recursive), horizontal/vertical movement that is a function of both visual target absolute size and depth oscillation period, and user-defined parameters for all oscillation modes, the set of four oscillations offered in this embodiment are found to be fundamental and, perhaps, without unduely complicating the nature of AVZS. The visual target may be either just a part of, or the entire, target application window: ergonomically, affecting the entire target application window seems to be optimized with respect to coding and most efficacious towards meeting the intended exercise goals. Also, because Microsoft Windows is the most popular platform, it will be given, with its commensurate gui, etc, as the platform of choice for this embodiment. A likely target application may very well be the corresponding Microsoft Word/Office; however, for this discussion, a similar but fictitious target application, “Editor”, will be used.

As is readily apparent, many embodiments may be assembled from the variations in oscillation modes, coding methods, et cetera; however, for this exemplary embodiment, the following specifications are employed for the reasons given previously: module-type; visual target is entire target application window; one user-specified oscillation mode, three fixed oscillation modes; Windows platform; and, generic, fictional word processor “Editor.”

Those individuals who are skilled in the Art are able to modify the code of Editor so as to include a module that creates a standard button-activated function (tool) AVZS, with all of its inherent capabilities, that presents itself as an icon within Editor application window. Upon activation, Editor displays, along with its standard barrage of buttons, a button to enable AVZS. At this stage, throughout the use of Editor, and after enabling AVZS with continued use of Editor, the focus is upon Editor; that is, user interface (mouse, keyboard, etc) retain full interactive operability with Editor. When the AVZS button is clicked (virtually depressed), a parameter window (graphical control element or widget) arises. This window allows the user to input, where permissible, the parameters employed by AVZS to move Editor window. As is typical, such a parameter window possesses brief descriptions adjacent input fields and two buttons at the bottom: “Cancel” and “OK”. Clicking “cancel” negates the enabling, or terminates the functioning, of AVZS; clicking “OK” enables AVZS with the parameters listed. Navigating about the AVZS parameter window is accomplished by standard mouse and tab controls; numerical input is by keyboard.

In this exemplary embodiment Editor parameters window displays only a single pair of user-defined parameters and they are for depth: range and period. Depth, as discussed earlier, simulates movement perpendicular to the display and is functionally and numerically equivalent to magnification. It is given as the range of 30% to 120% of full-screen size of Editor window. Period is the amount of time needed for AVZS to re-size Editor window from one end of the range to the other and back again; for this situation, the default period is given as 360 seconds. If each value of the depth range were the same number, Editor window merely oscillates in the other three modes at that magnification level; however, in this case, user sets the minimum at 40% and the maximum at 100% and the period to 120 seconds. Coded into this embodiment are the parameters for the other three oscillation modes: vertical, horizontal, and rotation. Given are fixed parameters within this exemplary embodiment that create a very subtle movement: vertical mode vertically shifts Editor window 2% of display height in 60 seconds; horizontal mode horizontally shifts Editor window 2% of display width in 60 seconds; and, rotation mode rotates Editor window 6 degrees in 60 seconds from the vertical about an axis perpendicular to the display. The default status of Editor window is centered at 100% screen size with an angular displacement of zero degrees; additionally, all initial motions, when enabled, are: away (virtual), upwards, rightwards, and clockwise.

Clicking the “OK” button will result in the movements, apparent and actual, of Editor window. Simultaneously and subtly, the visual target—this Editor application window complete with full functionality and focus—will shrink, shift rightwards and upwards, and rotate clockwise. It appears to move away from the user by shrinking; this shrinkage occurs at a rate of 1 percentage point per second. After the passage of 15 seconds, the Editor window will have shrunken by 15%, shifted to the right 1% of screen width, shifted upwards by 1% of screen height, and rotated 3 degrees. After the passage of 30 seconds, the Editor window will have shrunken by 30%, shifted left by 1% of screen width to return to horizontal mid-screen, shifted downwards by 1% of screen height to return to vertical mid-screen, and rotated counter-clockwise 3 degrees to return to vertical. After the passage of 45 seconds, Editor window will have shrunken by 45%, shifted left further by 1% of screen width, shifted downwards further by 1% of screen height, and rotated counter-clockwise further by 3 degrees. After the passage of 60 seconds, Editor window will have shrunken by 60%, shifted right by 1% of screen height to return to horizontal mid-screen, shifted upwards by 1% of screen height to return to vertical mid-screen, and rotated 3 degrees clockwise to return to vertical.

At this time, the depth mode has completed one half cycle whilst the other modes have each completed a full cycle. Here, Editor window is at is minimum size, vertical, and centered on the display. The process is quite symmetrical; hence, upon the completion of the remaining half-cycle of the depth mode during which time Editor window is enlarged gradually from a magnification of 40% to 100% and each of the other three mode of oscillation complete again a full cycle, Editor window will have returned to its default condition. This set of oscillations continues as long as AVZS is enabled.

1. eye exercise device manifested as software generating moving image upon device display functionally incorporated via plug-in, included module, stand-alone application, or other software modality into non-exercise, existing software comprising:
computing platform
operating system
read/write/graphics application
game application

2. device according to claim 1 wherein said image is interactive window, or portion thereof, of said existing software

3. device according to claim 2 wherein said interactive window retains user interface focus

4. device according to claim 2 wherein said interactive window is moved horizontally and/or vertically

5. device according to claim 2 wherein said interactive window is rotated

6. device according to claim 2 wherein said interactive window is magnified to simulate motion in direction perpendicular to device display

7. device according to claim 1 wherein functionally incorporated includes means by which software enabled eye exercise is performed simultaneously with tasks engaged upon executing said existing software
